(19) United States
(12) Patent Application Publication
(10) Pub. No.: US 2014/0143091 A1
(43) Pub. Date: May 22, 2014

(54) Context Based Shopping Capabilities When Viewing A Digital Image

(71) Applicant: DANTE CONSULTING, INC., Arlington, VA (US)

(72) Inventor: Pierre Malko, Arlington, VA (US)

(73) Assignee: DANTE CONSULTING, INC., Arlington, VA (US)

(21) Appl. No.: 13/839,919

(22) Filed: Mar. 15, 2013

Related U.S. Application Data
(60) Provisional application No. 61/729,273, filed on Nov. 21, 2012.

(51) Int. Cl. G06Q 30/06

(52) U.S. Cl. CPC G06Q 30/0623
USPC 705/26.61

(57) ABSTRACT

Presenting consumer information for and facilitating the purchase of a consumer product associated with a digital image. An image is presented having affiliated consumer products relevant to a displayed location in the image, a displayed product in the image, a displayed establishment in the image, and/or audio associated with the image. Information relevant to the purchase of the affiliated consumer products is presented in response to a selection including details or variations of the product. A transaction for purchase of the product is further facilitated.

### CROSS REFERENCE TO RELATED APPLICATION(S)

This application is a non-provisional patent application claiming the benefit of the filing date of U.S. Patent Application Ser. No. 61/729,273 filed on Nov. 21, 2012 and titled “Context Based Shopping Capabilities When Viewing A Digital Image,” which is hereby incorporated by reference.

### BACKGROUND

This invention relates to connecting product information with digital image data. More specifically, connections between digital image data and product data are established, thereby enabling selection and query of the digital image data.

Digital media, also referred to herein as digital image data, comes in different forms, and generally pertains to a numeric representation of an image. The digital media may come in different forms including, but not limited to, still images, graphic images, motion data, etc. Use of digital media continues to grow, as demonstrated through different forms of electronic commerce and electronic communication.

In the commercial environment, digital media has become common through digital content of news and information. For example, hardcopies of magazines and newspapers are also available in digital form. To support costs associated with creation and distribution of the digital content, advertisement is supported. Both the content and the advertisement(s) may include associated digital image(s). In one embodiment, the digital image(s) may be in the form of product endorsement. One focus of presenting digital image data is to attain the attention of a consumer. Challenges arise with viewing the digital image and querying data associated with the image. Often there is a disconnect that fails to enable a query over the product associated with the digital media, or a component illustrated in the digital media.

### BRIEF SUMMARY

This invention comprises a method, system, and computer program product for providing shopping capabilities and product information associated with image data.

In one aspect, a method is provided for presenting product information and facilitating a product transaction. At least one image is presented for viewing. The presented image is dissected into one or more image components. One of the dissected image components is selected and at least one commerce property associated with the selected image component is identified. Upon identification of the commerce properties, commerce information relevant to the purchase of the at least one commerce property is presented. In addition to the presentation of the commerce information, a transaction for purchase of the selected commerce property is facilitated.

In another aspect, a system is provided having a processing unit in communication with and to support execution of a functional unit. The functional unit is provided with tools embodied therewith, the tools including but not limited to, a presentation manager, a dissection manager, a selection manager, and a transaction manager. The presentation manager presents at least one image for viewing. Additionally, the presentation manager presents commerce information related to at least one commerce property associated with the presented image. The dissection manager is provided to dissect presented image(s) into one or more image components. The selection manager is provided to support the selection of one of the image components. The transaction manager is provided to facilitate a transaction involving the purchase of at least one commerce property.

In yet another aspect, a computer program product is provided for use with a digital image. The computer program product comprises of a computer-readable non-transitory storage medium having computer readable program code embodied thereon. When executed the computer program product presents at least one image for viewing, and the presented image is dissected into one or more image components. The computer program product selects at least one of the dissected image components and identifies at least one commerce property associated with the selected image component(s). Commerce information relevant to the purchase of the at least one commerce property is presented. Additionally, the computer program product facilitates a transaction for purchase of the at least one commerce property.

### BRIEF DESCRIPTION OF THE SEVERAL VIEWS OF THE DRAWINGS

The drawings reference herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 depicts a flow chart illustrating a method for presenting product details associated with digital media content.

FIG. 2 depicts a flow chart illustrating a method for presenting product details associated with a select area of an image.

FIG. 3 depicts an example of a digital image having associated commerce properties.

FIG. 4 depicts a flow chart illustrating a method for associating product specifications with a digital image for publishing to consumer channels.

FIG. 5 depicts a system illustrating tools to support the presentation of product details with digital media content.

FIG. 6 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a manager, to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

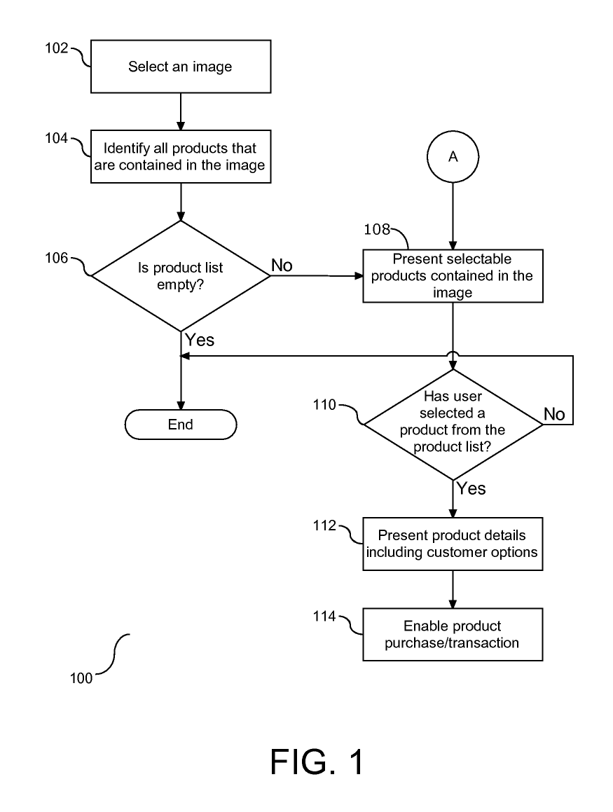

FIG. 1 depicts a flow chart (100) illustrating a method for presenting product details for objects associated with an image, and specifically selection of an image (102). The image can be in different forms, including a still image and a video. In one embodiment, the image is a consumer selected scene from a video in a consumer channel. Products that are contained within the image or image components that are associated with the image are identified. In one embodiment, the image components are associated with the image through reference to another object within the image, a location within the image, an establishment within the image, and/or an audio file associated with the image. If the image component is not in itself a commercial product, available commercial products associated with the identified image component are identified. Similarly, in one embodiment, the image may depict a service, with one or more service components in the image to be identified. Accordingly, one or more products or services associated with a selected image are identified.

Identified products or services from the image are presented (104), and in one embodiment, the presentation is in the form of a product or service list. For ease of description, the details of the identification and selection process will pertain to products and product components, although the invention may also encompass services and service components. These products are presented to provide a consumer with information and to enable the purchase of the product or a variation thereof. For example, a consumer may be viewing a television show in which there is a scene with multiple objects. When the consumer selects the scene, the system presents a list of the products or components depicted in the scene, each product listed with their brands, pricing and other data elements. The consumer can select one of these products to purchase and is presented by the options associated to these products that he/she must specify, for example, size, color, etc. In one embodiment, it is determined if the product list is empty (106). If the product list is empty, then there are no selectable products and the method is terminated. If the product list is not empty, then selectable products contained in the product list are presented (108).

At such time as the image is broken down into selectable products or components, any one of the products or components may be selected for further investigation or understanding. In one embodiment, the presentation of selectable components within the image provides an interactive aspect with the image and image components. It is determined if a product has been selected from the product list (110). A negative response is followed by a termination of the method. A positive response leads to a presentation of product information associated with the selected product (112). In one embodiment, the presentation of selectable components is in communication with the image(s), and remains in view and selectable together with the image, and as such time as the image is not available, the selectable components may not be available. Similarly, in one embodiment, the component(s) of a viewed image remain available subsequent to the viewing. In addition, an option is presented enabling purchase of the selected product (114). In one embodiment, the object is placed in virtual storage for eventual purchase e.g. a virtual shopping cart. Accordingly, images are parsed to ascertain selectable products for purchase and components therein.

The presented product information is dependent on the product. For products involving merchandise the product information may include but is not limited to, a description of the product, one or more purchase options for the product, pricing information associated with the product, fulfillment information regarding distribution of the product, and/or selectable consumer variations of the product e.g. size and/or color. Product information involving products associated with a particular location found in or associated with the selected image may be provided. This information may include but is not limited to, information regarding consumer products affiliated with the particular location, travel related information e.g. plane tickets to the particular location, event information regarding events found near the particular location, and/or pricing information for each aforementioned consumer product affiliated with the particular location. Product information involving products associated with a particular establishment may be provided. This information may include but is not limited to, products associated with the particular establishment e.g. a book from a book store, reservation information associated with the particular establishment e.g. placing a reservation at a restaurant or hotel, and event information associated with the particular establishment e.g. tickets to an upcoming musical performance at a concert arena. If the selected image is a scene from a video, audio information associated with the scene may additionally be presented. Accordingly, product and/or service information is provided for images and image components.

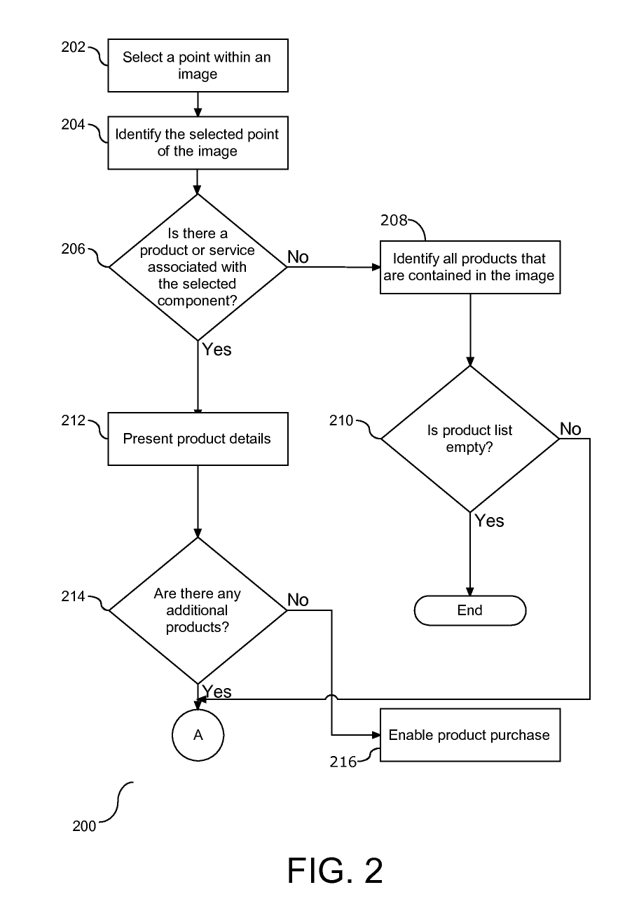

In one embodiment, a section of the image is selected and only products contained within the image section or associated with the image section are identified. The section of the image may include but is not limited to, a selected object in the image, a selected location displayed in the image, or a selected coordinate of the image. FIG. 2 depicts a flow chart (200) illustrating a method for selecting a particular section of an image. A point or area within an image is selected (202). Any object or location associated with the selection is identified (204), and it is determined if there is an identifiable product or service associated with the selected component associated with the image (206). In one embodiment, a negative response is followed by a termination of the method (not shown). However, in one embodiment, a negative response to the determination at step (206) includes an identification of all products or services contained within the selected image (208). All identified products contained within the selected image are placed in a product list. It is then determined if the product list is empty (210). A positive response is followed by a termination of the method. A negative response is followed by a return to step (108). If there is an identifiable product associated with the point on the image, the product details are presented (212), and it is determined if there are any additional products associated with the identified product (214). If there are no other associated products, the product is enabled for selected purchase (216). Conversely, if there are other associated products, the process returns to step (108). Accordingly, product information regarding a particular section of an image is provided.

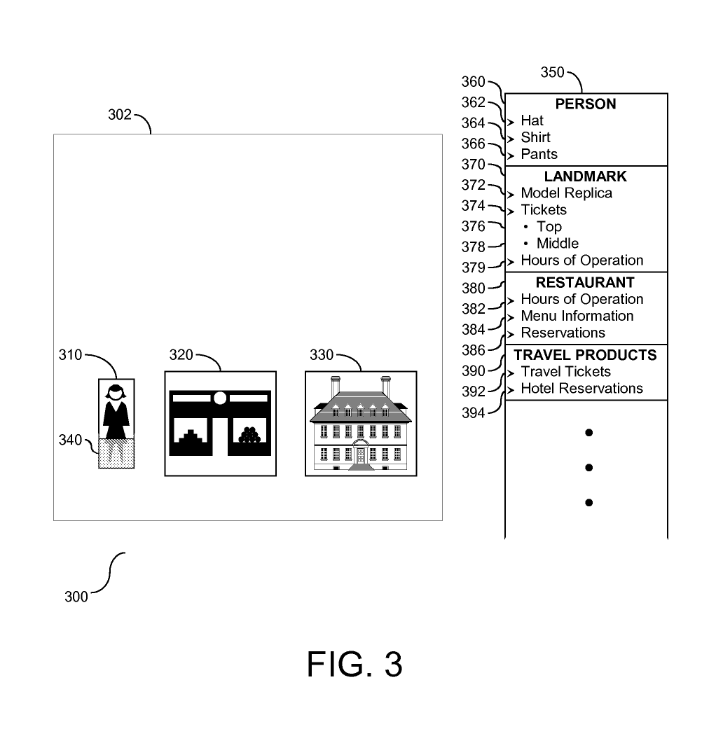

FIG. 3 illustrates an example (300) of an image (302) with selectable components therein and a secondary window (350) presenting product and service information associated with the image. The consumer products or services associated with the image and image components are identified, as demonstrated in FIGS. 1 and 2. In this example, a person (310), a commercial establishment (320), and a famous landmark (330) are depicted and all products associated with the person (310), establishment (320), and landmark (330) are identified. For illustrative purposes, the components shown in image (300) are identified as separate selectable components. In one embodiment, a subsection of the image is selected for associated consumer product identification. For example, subsection (340) is associated with the person (310) illustrated in the image. A selection of the person is shown at (360) with selectable components (362), (364), and (366) listed. In one embodiment, as each selectable component is viewed or identified with a pointing device, a secondary window (350) may appear with product and/or service details, including but not limited to product identification, pricing, location to purchase, designer, etc. A selection within the secondary window may be followed by presentation of options associated with the product details, including but not limited to, product particulars such as size, colors, etc. Accordingly, as an image is viewed or selected, identifiable components are visually presented with product details.

Products associated with objects in the image that are not necessarily visible in the image are identified. For example, with regards to the famous landmark depicted in the image (330), a purchasable model replica of the structure (372) or various purchasable tickets (374), such as tickets to the top (376) or middle of the landmark (378), and hours of operation (379) may be listed under the identified landmark name (370). In one embodiment, reservation information is displayed with the select image (300). For example, through selection of the image (300) reservation information is displayed regarding a reservation for admission to the establishment (320). In this example, the establishment (320) is a restaurant (380) and displays hours of operation (382), menu information (384) and reservation information including providing access to make a reservation (386). In one embodiment, where the structure (330) and/or the establishment (320) are associated with a particular location, a geographic identifier is implemented to present location sensitive products, such as travel related products (390) associated with the particular location e.g. travel tickets to the particular location (392) and/or reservations at a hotel near the particular location (394). Accordingly, products associated with the selected image are identified and displayed.

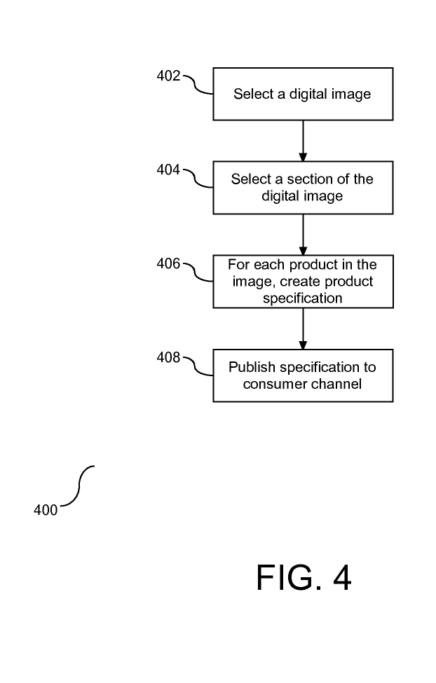

FIG. 4 is a flow chart (400) illustrating a process for an administrator to associate product specifications with a digital image and publish these specifications to the various channels in which a merchant sells the products. A digital image is selected (402). This digital image may be a frame from a video or a picture. In one embodiment, a section of the digital image is selected (404). A product specification is created for each product in the digital image (406). In the embodiment where a section of the digital image is selected, a product specification is created for each product in the selected section of the digital image. A product specification may include but is not limited to: a name of the product, a description of the product, a price of the product, customer selectable options such as the size and/or color of the product, and delivery options. This specification is published to available consumer channels in which the digital image appears (408). These consumer channels include any medium in which a consumer can interact with a digital image, e.g. a digital magazine, a digital video player, an online store, a mobile application, and a television. Accordingly, consumer information and purchasable means are provided with a digital image.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium would include the following: an electrical connection having one or more wires, a portable computer diskette, a hard disk, a random access memory (RAM), a read-only memory (ROM), an erasable programmable read only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The functional unit(s) described in this specification has been labeled with tools in the form of manager(s). A manager may be implemented in programmable hardware devices such as field programmable gate arrays, programmable array logic, programmable logic devices, or the like. The manager(s) may also be implemented in software for processing by various types of processors. An identified manager of executable code may, for instance, comprise one or more physical or logical blocks of computer instructions which may, for instance, be organized as an object, procedure, function, or other construct. Nevertheless, the executable of an identified manager need not be physically located together, but may comprise disparate instructions stored in different locations which, when joined logically together, comprise the managers and achieve the stated purpose of the managers and directors.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

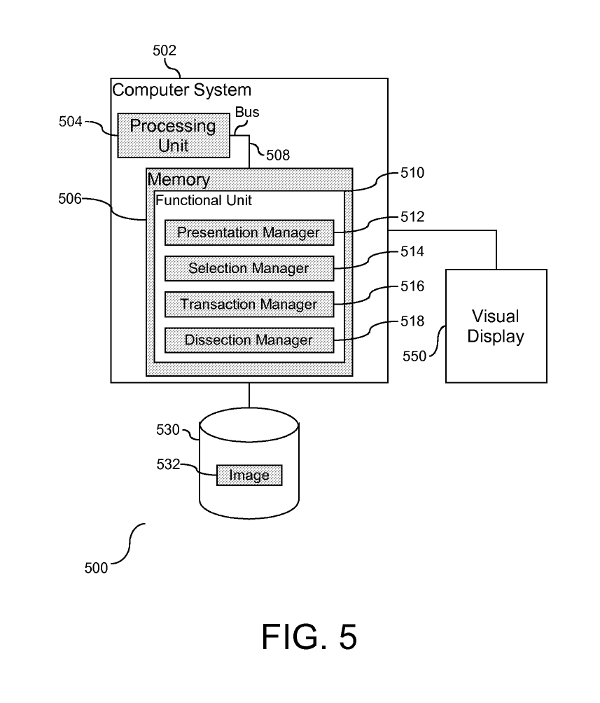

FIG. 5 is a block diagram (500) illustrating tools embedded in a computer system (502) to support the presentation of product information and facilitation of a consumer transaction. A processing unit (504) is provided in the computer system (502) in communication with memory (506) across a bus (508). The processing unit (504) is further in communication with a functional unit (510) to support execution of the functional unit (510). The computer system is in communication with data storage (530). The data storage (530) contains at least one image (532) and is either local to the system or in one embodiment, accessed across a network (not shown). The functional unit (510) contains a plurality of tools embodied therewith, including but not limited to, a presentation manager (512), a selection manager (514), a transaction manager (516), and a in one embodiment, a dissection manager (518).

The presentation manager (512) is in communication with data storage (530) and presents at least one image for viewing. In one embodiment, the image is presented on a visual display (550) in communication with the presentation manager (512). The presentation manager (512) displays a commerce property relevant to at least one commercial product associated with the displayed image. In one embodiment, the dissection manager (518) is provided in communication with the presentation manager (512). The dissection manager (518) dissects the presented image into multiple sections. In this embodiment, the selection manager (514) is provided in communication with the dissection manager (518) to support selection of at least one of the multiple sections. In a different embodiment, the selection manager (514), in communication with the presentation manager (512) supports the selection of a commerce property associated with an object in the displayed image. In one embodiment, the presentation manager (512) only presents product information relevant to the selection supported by the selection manager (514). The transaction manager, in communication with the presentation manager, facilitates a transaction for purchase of a commerce property associated with the presented commerce information. Accordingly, the presentation manager presents information related to a commerce property associated with the presented image, or in one embodiment a select portion of the presented image, and the transaction manager facilitates a transaction for purchase associated with the commerce information.

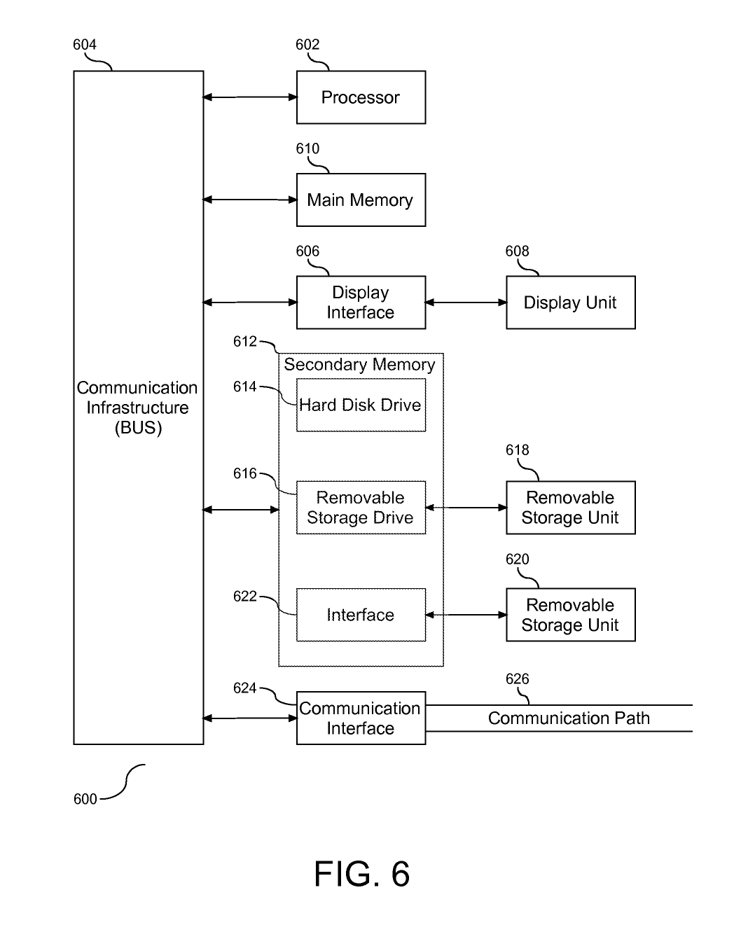

Referring now to the block diagram (600) of FIG. 6, additional details are now described with respect to implementing an embodiment of the present invention. The computer system includes one or more processors, such as a processor (602). The processor (602) is connected to a communication infrastructure (604) (e.g., a communications bus, cross-over bar, or network).

The computer system can include a display interface (606) that forwards graphics, text, and other data from the communication infrastructure (604) (or from a frame buffer not shown) for display on a display unit (608). The computer system also includes a main memory (610), preferably random access memory (RAM), and may also include a secondary memory (612). The secondary memory (612) may include, for example, a hard disk drive (614) (or alternative persistent storage device) and/or a removable storage drive (616), representing, for example, a floppy disk drive, a magnetic tape drive, or an optical disk drive. The removable storage drive (616) reads from and/or writes to a removable storage unit (618) in a manner well known to those having ordinary skill in the art. Removable storage unit (618) represents, for example, a floppy disk, a compact disc, a magnetic tape, or an optical disk, etc., which is read by and written to by a removable storage drive (616). As will be appreciated, the removable storage unit (618) includes a computer readable medium having stored therein computer software and/or data.

In alternative embodiments, the secondary memory (612) may include other similar means for allowing computer programs or other instructions to be loaded into the computer system. Such means may include, for example, a removable storage unit (620) and an interface (622). Examples of such means may include a program package and package interface (such as that found in video game devices), a removable memory chip (such as an EPROM, or PROM) and associated socket, and other removable storage units (620) and interfaces (622) which allow software and data to be transferred from the removable storage unit (620) to the computer system.

The computer system may also include a communications interface (624). Communications interface (624) allows software and data to be transferred between the computer system and external devices. Examples of communications interface (624) may include a modem, a network interface (such as an Ethernet card), a communications port, or a PCMCIA slot and card, etc. Software and data transferred via communications interface (624) are in the form of signals which may be, for example, electronic, electromagnetic, optical, or other signals capable of being received by communications interface (624). These signals are provided to communications interface (624) via a communications path (i.e., channel) (626). This communications path (626) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (610) and secondary memory (612), removable storage drive (616), and a hard disk installed in hard disk drive or alternative persistent storage device (614).

Computer programs (also called computer control logic) are stored in main memory (610) and/or secondary memory (612). Computer programs may also be received via a communication interface (624). Such computer programs, when run, enable the computer system to perform the features of the present invention as discussed herein. In particular, the computer programs, when run, enable the processor (602) to perform the features of the computer system. Accordingly, such computer programs represent controllers of the computer system.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the enhanced cloud computing model supports flexibility with respect to transaction processing, including, but not limited to, optimizing the storage system and processing transactions responsive to the optimized storage system.

### ALTERNATIVE EMBODIMENT(S)

It will be appreciated that, although specific embodiments of the invention have been described herein for purposes of illustration, various modifications may be made without departing from the spirit and scope of the invention. Identification of product and service details may occur on different visualizations, including but not limited to, mobile applications and non-mobile applications. With respect to the mobile applications, product and/or service details may be tied with the geographic location of the mobile device, and provide directions to a retail establishment associated with the product or service details. Accordingly, the scope of protection of this invention is limited only by the following claims and their equivalents.

I claim:

1. A method comprising:
presenting at least one image for viewing;
dissecting the presented image into one or more image components;
selecting at least one of the dissected image components and identifying at least one commerce property associated with the at least one selected image component;
presenting commerce information relevant to the purchase of the at least one commerce property; and
facilitating a transaction for purchase of the at least one commerce property.

2. The method of claim 1, wherein the selected image component is visible in the presented image, and the presented commerce information is selected from the group consisting of: a description of the item, purchase options, pricing information associated with the item, fulfillment information regarding distribution of the item, consumer variations of the product, and combinations thereof.

3. The method of claim 1, wherein the selected dissected image component has a geographic identifier associated with a setting of the image, and information regarding the geographic identifier is selected from the group consisting of: information regarding consumer products, travel related information, event information, and any combination thereof.

4. The method of claim 1, wherein the selected dissecting image component has an establishment identifier associated with a setting of the image, and information regarding the establishment identifier is selected from the group consisting of: any additional products associated with the establishment identifier, reservation information, event information, and any combination thereof.

5. The method of claim 1, wherein the presented image is a digital image or digital video.

6. The method of claim 5, wherein the presented image includes audio as a selectable component.

7. A system comprising:
a processing unit in communication with and to support execution of a functional unit, the functional unit having tools embodied therewith, the tools comprising:
a presentation manager to present at least one image for viewing and commerce information related to at least one commerce property associated with the presented image;
a dissection manager to dissect the at least one presented image into one or more image components;
a selection manager to support selection of one of the image components; and
a transaction manager to facilitate a transaction for purchase of the at least one commerce property;

8. The system of claim 7, further comprising the presentation manager to present the selected image component in the presented image, and the presented commerce information is selected from the group consisting of: a description of the item, purchase options, pricing information associated with the item, fulfillment information regarding distribution of the item, consumer variations of the product, and combinations thereof.

9. The system of claim 7, wherein the selection manager selects a dissected image component that has a geographic identifier associated with a setting of the image, and information regarding the geographic identifier is selected from the group consisting of: information regarding consumer products, travel related information, event information, and any combination thereof.

10. The system of claim 7, wherein the selection manager selects a dissecting image component that has an establishment identifier associated with a setting of the image, and information regarding the establishment identifier is selected from the group consisting of: any additional products associated with the establishment identifier, reservation information, event information, and any combination thereof.

11. The system of claim 7, wherein the image presented by the presentation manager is a digital image or digital video.

12. The method of claim 11, wherein the presented image includes audio as a selectable component by the selection manager.

13. A computer program product for use with a digital image, the computer program product comprising a computer-readable non-transitory storage medium having computer readable program code embodied thereon, which when executed causes a computer to implement the method comprising:
presenting at least one image for viewing;
dissecting the presented image into one or more image components;
selecting at least one of the dissected image components and identifying at least one commerce property associated with the at least one selected image component;
presenting commerce information relevant to the purchase of the at least one commerce property; and
facilitating a transaction for purchase of the at least one commerce property.

14. The computer program product of claim 13, wherein the selected image component is visible in the presented image, and the presented commerce information is selected from the group consisting of: a description of the item, purchase options, pricing information associated with the item, fulfillment information regarding distribution of the item, consumer variations of the product, and combinations thereof.

15. The computer program product of claim 13, wherein the selected dissected image component has a geographic identifier associated with a setting of the image, and information regarding the geographic identifier is selected from the group consisting of: information regarding consumer products, travel related information, event information, and any combination thereof.

16. The computer program product of claim 13, wherein the selected dissecting image component has an establishment identifier associated with a setting of the image, and information regarding the establishment identifier is selected from the group consisting of: any additional products associated with the establishment identifier, reservation information, event information, and any combination thereof.

17. The computer program product of claim 13, wherein the presented image is a digital image or digital video.

18. The computer program product of claim 17, wherein the presented image includes audio as a selectable component.
